(19) United States
(12) Patent Application Publication
(10) Pub. No.: US 2006/0117201 A1
(43) Pub. Date: Jun. 1, 2006

(54) Variable pipeline circuit

(75) Inventor: Ronny Schneider, Xi'an (CN)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(73) Assignee: Infineon Technologies North America Corp.

(21) Appl. No.: 10/999,596

(22) Filed: Nov. 30, 2004

(51) Int. Cl. G06F 1/12

(52) U.S. Cl. 713/400

(57) ABSTRACT

A variable pipeline comprises a first pipeline element configured to latch a first signal in response to a first edge of a clock signal to provide a second signal, a selection circuit configured to select the second signal and pass the second signal to provide a third signal, and a second pipeline element configured to latch the third signal in response to a second edge of the clock signal to provide a fourth signal.

### BACKGROUND

Integrated circuits, such as dynamic random access memories (DRAMs), synchronous dynamic random access memories (SDRAMs), double data rate synchronous dynamic random access memories (DDR-SDRAMs), and double data rate two synchronous dynamic random access memories (DDR2-SDRAMs), are operating at increasingly higher frequencies. To perform various functions in integrated circuits, many times signals have to pass through a pipeline, such as a latency counter, to delay the signal and align the signal with other signals.

Typically, variable pipelines include a chain of several pipeline elements. A signal to be delayed is passed through the first pipeline element and each successive pipeline element to delay the signal a desired amount. The output of each pipeline element is passed to a selection circuit that selects the output from the pipeline element providing the desired delay. The selection circuit further delays the output signal based on the number of logic gates the output signal passes through in the selection circuit. As the frequency of integrated circuits increase, the delay of the selection circuit becomes undesirable. Reducing the signal run times in the integrated circuits is advantageous as the frequencies of the integrated circuits increase. The signal run times can be reduced by reducing or eliminating unwanted delays, such as the delay of a signal through a selection circuit.

### SUMMARY

One embodiment of the present invention provides a variable pipeline. The variable pipeline comprises a first pipeline element configured to latch a first signal in response to a first edge of a clock signal to provide a second signal, a selection circuit configured to select the second signal and pass the second signal to provide a third signal, and a second pipeline element configured to latch the third signal in response to a second edge of the clock signal to provide a fourth signal. In one embodiment, the variable pipeline is suitable for use in a memory circuit.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a block diagram illustrating one embodiment of a memory system including a variable pipeline.

FIG. 2 is a schematic diagram illustrating one embodiment of the variable pipeline.

FIG. 3 is a timing diagram illustrating one embodiment of the timing of signals for the variable pipeline.

### DETAILED DESCRIPTION

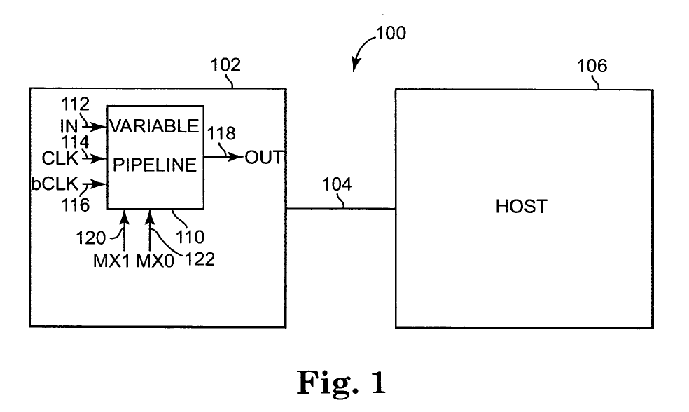

FIG. 1 is a block diagram illustrating one embodiment of a memory system 100. Memory system 100 includes memory circuit 102 and host 106. Memory circuit 102 is electrically coupled to host 106 through communication link 104. Memory circuit 102 includes variable pipeline 110. Variable pipeline 110 receives an input signal (IN) on IN signal path 112, a clock (CLK) signal on CLK signal path 114, an inverted clock (bCLK) signal on bCLK signal path 116, a first selection (MX0) signal on MX0 signal path 122, and a second selection (MX1) signal on MX1 signal path 120. Variable pipeline 110 provides an output (OUT) signal on OUT signal path 118.

Based on the MX1 signal on MX1 signal path 120 and the MX0 signal on MX0 signal path 122, variable pipeline 110 delays the IN signal on IN signal path 112 through a selected number of pipeline elements to provide the OUT signal on OUT signal path 118. The delay through the selection circuit of variable pipeline 110 does not increase the total delay between the IN signal and the OUT signal.

In one embodiment, memory circuit 102 comprises a random access memory, such as a dynamic random access memory (DRAM), synchronous dynamic random access memory (SDRAM), double data rate synchronous dynamic random access memory (DDR-SDRAM), or double data rate two synchronous dynamic random access memory (DDR2-SDRAM). Although variable pipeline 110 is described with reference to memory circuit 102, variable pipeline 110 is applicable to many other suitable types of circuits.

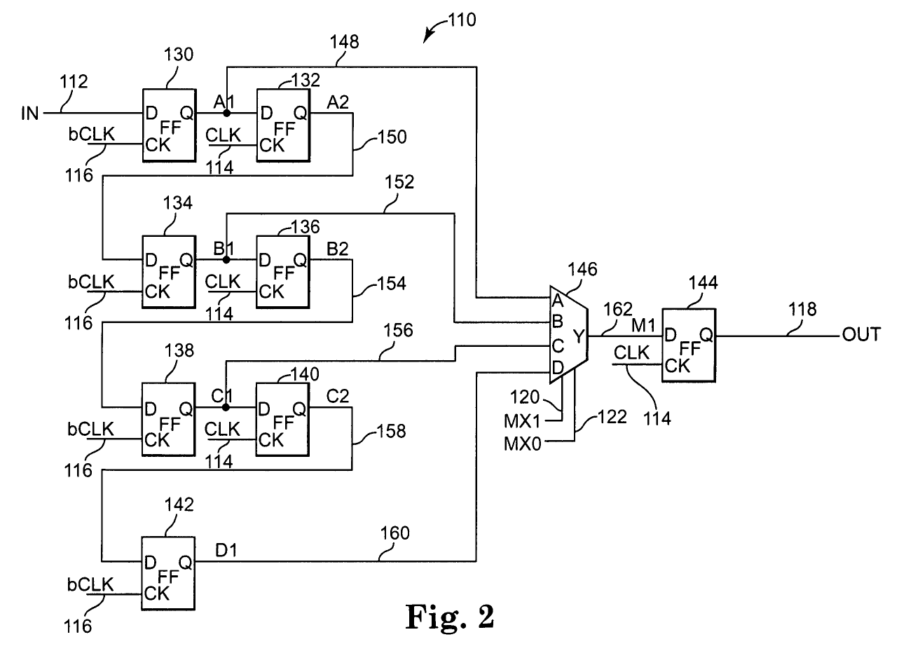

FIG. 2 is a schematic diagram illustrating one embodiment of variable pipeline 110. Variable pipeline 110 includes a chain of pipeline elements, including flip-flop latches 130-144, and multiplexer 146. IN signal path 112 is electrically coupled to input D of flip-flop latch 130. The bCLK signal path 116 is electrically coupled to the clock (CK) inputs of flip-flop latches 130, 134, 138, and 142. Output Q of flip-flop latch 130 is electrically coupled to input D of flip-flop latch 132 and input A of multiplexer 146 through Al signal path 148. CLK signal path 114 is electrically coupled to the CK inputs of flip-flops 132, 136, 140, and 144.

Output Q of flip-flop latch 132 is electrically coupled to input D of flip-flop latch 134 through A2 signal path 150. Output Q of flip-flop latch 134 is electrically coupled to input D of flip-flop latch 136 and input B of multiplexer 146 through B1 signal path 152. Output Q of flip-flop latch 136 is electrically coupled to input D of flip-flop latch 138 through B2 signal path 154. Output Q of flip-flop latch 138 is electrically coupled to input D of flip-flop latch 140 and input C of multiplexer 146 through C1 signal path 156.

Output Q of flip-flop latch 140 is electrically coupled to input D of flip-flop latch 142 through C2 signal path 158. Output Q of flip-flop latch 142 is electrically coupled to input D of multiplexer 146 through D1 signal path 160. The first selection signal (MX0) path 122 is electrically coupled to an input of multiplexer 146. The second selection signal (MX1) path 120 is electrically coupled to another input of multiplexer 146. Output Y of multiplexer 146 is electrically coupled to input D of flip-flop latch 144 through M1 signal path 162. Flip-flop latch 144 provides the OUT signal on OUT signal path 118.

Flip-flop latch 130 receives the IN signal on IN signal path 112 and the bCLK signal on bCLK signal path 116 and provides the A1 signal on A1 signal path 148. Flip-flop latch 130 latches the IN signal on each rising edge of the bCLK signal. With a logic low IN signal and in response to a rising edge of the bCLK signal, flip-flop latch 130 latches the logic low IN signal to provide a logic low A1 signal. With a logic high IN signal and in response to a rising edge of the bCLK signal, flip-flop latch 130 latches the logic high IN signal to provide a logic high A1 signal.

Flip-flop latch 132 receives the A1 signal on A1 signal path 148 and the CLK signal on CLK signal path 114 and provides the A2 signal on A2 signal path 150. Flip-flop latch 132 latches the A1 signal on each rising edge of the CLK signal. With a logic low A1 signal and in response to a rising edge of the CLK signal, flip-flop latch 132 latches the logic low A1 signal to provide a logic low A2 signal. With a logic high A1 signal and in response to a rising edge of the CLK signal, flip-flop latch 132 latches the logic high A1 signal to provide a logic high A2 signal.

Flip-flop latch 134 receives the A2 signal on A2 signal path 150 and the bCLK signal on bCLK signal path 116 and provides the B1 signal on B1 signal path 152. Flip-flop latch 134 latches the A2 signal on each rising edge of the bCLK signal. With a logic low A2 signal and in response to a rising edge of the bCLK signal, flip-flop latch 134 latches the logic low A2 signal to provide a logic low B1 signal. With a logic high A2 signal and in response to a rising edge of the bCLK signal, flip-flop latch 134 latches the logic high A2 signal to provide a logic high B1 signal.

Flip-flop latch 136 receives the B1 signal on B1 signal path 152 and the CLK signal on CLK signal path 114 and provides the B2 signal on B2 signal path 154. Flip-flop latch 136 latches the B1 signal on each rising edge of the CLK signal. With a logic low B1 signal and in response to a rising edge of the CLK signal, flip-flop latch 136 latches the logic low B1 signal to provide a logic low B2 signal. With a logic high B1 signal and in response to a rising edge of the CLK signal, flip-flop latch 136 latches the logic high B1 signal to provide a logic high B2 signal.

Flip-flop latch 138 receives the B2 signal on B2 signal path 154 and the bCLK signal on bCLK signal path 116 and provides the C1 signal on C1 signal path 156. Flip-flop latch 138 latches the B2 signal on each rising edge of the bCLK signal. With a logic low B2 signal and in response to a rising edge of the bCLK signal, flip-flop latch 138 latches the logic low B2 signal to provide a logic low C1 signal. With a logic high B2 signal and in response to a rising edge of the bCLK signal, flip-flop latch 138 latches the logic high B2 signal to provide a logic high C1 signal.

Flip-flop latch 140 receives the C1 signal on C1 signal path 156 and the CLK signal on CLK signal path 114 and provides the C2 signal on C2 signal path 158. Flip-flop latch 140 latches the C1 signal on each rising edge of the CLK signal. With a logic low C1 signal and in response to a rising edge of the CLK signal, flip-flop latch 140 latches the logic low C1 signal to provide a logic low C2 signal. With a logic high C1 signal and in response to a rising edge of the CLK signal, flip-flop latch 140 latches the logic high C1 signal to provide a logic high C2 signal.

Flip-flop latch 142 receives the C2 signal on C2 signal path 158 and the bCLK signal on bCLK signal path 116 and provides the D1 signal on D1 signal path 160. Flip-flop latch 142 latches the C2 signal on each rising edge of the bCLK signal. With a logic low C2 signal and in response to a rising edge of the bCLK signal, flip-flop latch 142 latches the logic low C2 signal to provide a logic low D1 signal. With a logic high C2 signal and in response to a rising edge of the bCLK signal, flip-flop latch 142 latches the logic high C2 signal to provide a logic high D1 signal.

Multiplexer 146 receives the A1 signal on A1 signal path 148, the B1 signal on B1 signal path 152, the C1 signal on C1 signal path 156, the D1 signal on D1 signal path 160, the MX1 signal on MX1 signal path 120, and the MX0 signal on MX0 signal path 122. Multiplexer 146 provides the M1 signal on M1 signal path 120. Based on the MX1 signal and the MX0 signal, multiplexer 146 passes one of the input signals, A1, B1, C1, or D1, to provide the M1 signal.

In one embodiment, with a logic low MX0 signal and a logic low MX1 signal, input A of multiplexer 146 is selected to pass the A1 signal to provide the M1 signal. With a logic high MX0 signal and a logic low MX1 signal, input B of multiplexer 146 is selected to pass the B1 signal to provide the M1 signal. With a logic low MX0 signal and a logic high MX1 signal, input C of multiplexer 146 is selected to pass the C1 signal to provide the M1 signal. With a logic high MX0 signal and a logic high MX1 signal, input D of multiplexer 146 is selected to pass the D1 signal to provide the M1 signal.

Flip-flop latch 144 receives the M1 signal on M1 signal path 162 and the CLK signal on CLK signal path 114 and provides the OUT signal on OUT signal path 118. Flip-flop latch 144 latches the M1 signal on each rising edge of the CLK signal. With a logic low M1 signal and in response to a rising edge of the CLK signal, flip-flop latch 144 latches the logic low M1 signal to provide a logic low OUT signal. With a logic high M1 signal and in response to a rising edge of the CLK signal, flip-flop latch 144 latches the logic high M1 signal to provide a logic high OUT signal.

In one embodiment, variable pipeline 110 includes more than the four illustrated pipeline stages to provide more than four possible delay lengths. In another embodiment, variable pipeline 110 includes less than the four illustrated pipeline stages to provide less than four possible delay lengths. Multiplexer 146 is selected based on the number of pipeline stages.

In operation, the MX0 signal and the MX1 signal inputs to multiplexer 146 are set to select the input signal, A1, B1, C1, or D1, to pass to M1 signal path 162 to provide the M1 signal. The IN signal on IN signal path 112 is latched by flip-flop latch 130 on the rising edge of the bCLK signal to provide the A1 signal. If multiplexer 146 is set to pass the A1 signal, then the A1 signal is also passed by multiplexer 146 to provide the M1 signal on the rising edge of the bCLK signal. On the rising edge of the CLK signal, the M1 signal is latched by flip-flop latch 144 to provide the OUT signal on OUT signal path 118. The delay of the A1 signal through multiplexer 146 is hidden between the rising edge of the bCLK signal and the rising edge of the CLK signal, such that the delay does not increase the overall delay between the IN signal and the OUT signal. In one embodiment, with multiplexer 146 set to pass the A1 signal, the clock signals to the CK inputs of flip-flop latches 132, 134, 136, 138, 140, and 142 are disabled to prevent flip-flop latches 132, 134, 136, 138, 140, and 142 from operating. By disabling the CK inputs to the unused flip-flop latches, power is conserved.

If multiplexer 146 is set to pass the B1 signal, then the A1 signal is latched by flip-flop latch 132 on the rising edge of the CLK signal to provide the A2 signal. The A2 signal is latched by flip-flop latch 134 on the next rising edge of the bCLK signal to provide the B1 signal. The B1 signal is also passed by multiplexer 146 to provide the M1 signal on the rising edge of the bCLK signal. On the rising edge of the next CLK signal, the M1 signal is latched by flip-flop latch 144 to provide the OUT signal on OUT signal path 118. Once again, the delay of the B1 signal through multiplexer 146 is hidden, such that the delay does not increase the overall delay between the IN signal and the OUT signal. In one embodiment, with multiplexer 146 set to pass the B1 signal, the clock signals to the CK inputs of flip-flop latches 136, 138, 140, and 142 are disabled to prevent flip-flop latches 136, 138, 140, and 142 from operating. By disabling the CK inputs to the unused flip-flop latches, power is conserved.

If multiplexer 146 is set to pass the C1 signal, then the B1 signal is latched by flip-flop latch 136 on the next rising edge of the CLK signal to provide the B2 signal. The B2 signal is latched by flip-flop latch 138 on the next rising edge of the bCLK signal to provide the C1 signal. The C1 signal is also passed by multiplexer 146 to provide the M1 signal on the rising edge of the bCLK signal. On the rising edge of the next CLK signal, the M1 signal is latched by flip-flop latch 144 to provide the OUT signal on OUT signal path 118. Once again, the delay of the C1 signal through multiplexer 146 is hidden, such that the delay does not increase the overall delay between the IN signal and the OUT signal. In one embodiment, with multiplexer 146 set to pass the C1 signal, the clock signals to the CK inputs of flip-flop latches 140 and 142 are disabled to prevent flip-flop latches 140 and 142 from operating. By disabling the CK inputs to the unused flip-flop latches, power is conserved.

If multiplexer 146 is set to pass the D1 signal, then the C1 signal is latched by flip-flop latch 140 on the next rising edge of the CLK signal to provide the C2 signal. The C2 signal is latched by flip-flop latch 142 on the next rising edge of the bCLK signal to provide the D1 signal. The D1 signal is also passed by multiplexer 146 to provide the M1 signal on the rising edge of the bCLK signal. On the rising edge of the next CLK signal, the M1 signal is latched by flip-flop latch 144 to provide the OUT signal on OUT signal path 118. Once again, the delay of the D1 signal through multiplexer 146 is hidden, such that the delay does not increase the overall delay between the IN signal and the OUT signal.

In one embodiment, the CK inputs to flip-flop latches 130-144 are reversed, such that the CLK signal is provided to the CK inputs of flip-flop latches 130, 134, 138, and 142, and the bCLK signal is provided to the CK inputs of flip-flop latches 132, 136, 140, and 144. In another embodiment, flip-flop latches 130-144 latch the signal on input D on the falling edge of the CK signal input instead of the rising edge of the CK signal input. In one form of the invention, a single CK signal input is used for all latches 130-144. In this embodiment, latches 130, 134, 138, and 142 latch the signal on input D on the rising edge of the CK signal, and latches 132, 136, 140, and 144 latch the signal on input D on the falling edge of the CK signal, or vice versa.

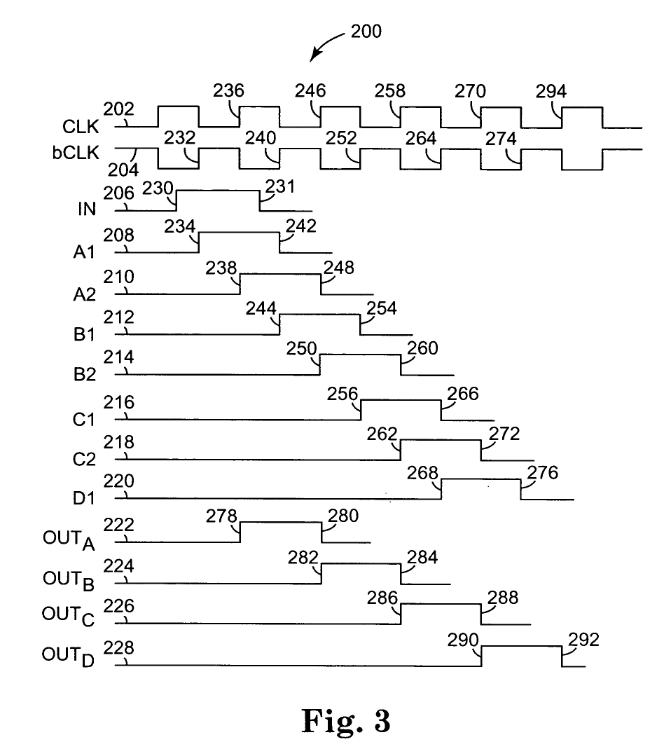

FIG. 3 is a timing diagram 200 illustrating one embodiment of the timing of signals for variable pipeline 110. Timing diagram 200 includes CLK signal 202 on CLK signal path 114, bCLK signal 204 on bCLK signal path 116, IN signal 206 on IN signal path 112, A1 signal 208 on A1 signal path 148, A2 signal 210 on A2 signal path 150, B1 signal 212 on B1 signal path 152, B2 signal 214 on B2 signal path 154, C1 signal 216 on C1 signal path 156, C2 signal 218 on C2 signal path 158, and D1 signal 220 on D1 signal path 160. Timing diagram 200 also includes OUT_{A} signal 222 on OUT signal path 118 with multiplexer 146 set to pass A1 signal 208, OUT_{B} signal 224 on OUT signal path 118 with multiplexer 146 set to pass B1 signal 212, OUT_{C} signal 226 on OUT signal path 118 with multiplexer 146 set to pass C1 signal 216, and OUT_{D} signal 228 on OUT signal path 118 with multiplexer 146 set to pass D1 signal 220.

The bCLK signal 204 is inverted with respect to CLK signal 202. IN signal 206 transitions to a logic high at 230. In response to rising edge 232 of bCLK signal 204, flip-flop latch 130 latches IN signal 206 to provide rising edge 234 of A1 signal 208. In response to rising edge 236 of CLK signal 202, flip-flop latch 132 latches logic high A1 signal 208 to provide rising edge 238 of A2 signal 210. IN signal 206 transitions to a logic low at 231. In response to rising edge 240 of bCLK signal 204, flip-flop latch 130 latches logic low IN signal 206 to provide falling edge 242 of A1 signal 208. Also in response to rising edge 240 of bCLK signal 204, flip-flop latch 134 latches logic high A2 signal 210 to provide rising edge 244 of B1 signal 212.

In response to rising edge 246 of CLK signal 202, flip-flop latch 132 latches logic low A1 signal 208 to provide falling edge 248 of A2 signal 210. Also in response to rising edge 246 of CLK signal 202, flip-flop latch 136 latches logic high B1 signal 212 to provide rising edge 250 of B2 signal 214. In response to rising edge 252 of bCLK signal 204, flip-flop latch 134 latches logic low A2 signal 210 to provide falling edge 254 of B1 signal 212. Also in response to rising edge 252 of bCLK signal 204, flip-flop latch 138 latches logic high B2 signal 214 to provide rising edge 256 of C1 signal 216. In response to rising edge 258 of CLK signal 202, flip-flop latch 136 latches logic low B1 signal 212 to provide falling edge 260 of B2 signal 214. Also in response to rising edge 258 of CLK signal 202, flip-flop latch 140 latches logic high C1 signal 216 to provide rising edge 262 of C2 signal 218.

In response to rising edge 264 of bCLK signal 204, flip-flop latch 138 latches logic low B2 signal 214 to provide falling edge 266 of Cl signal 216. Also in response to rising edge 264 of bCLK signal 204, flip-flop latch 142 latches logic high C2 signal 218 to provide rising edge 268 of D1 signal 220. In response to rising edge 270 of CLK signal 202, flip-flop latch 140 latches logic low C1 signal 216 to provide falling edge 272 of C2 signal 218. In response to rising edge 274 of bCLK signal 204, flip-flop latch 142 latches logic low C2 signal 218 to provide falling edge 276 of D1 signal 220.

If multiplexer 146 is set to pass A1 signal 208, in response to rising edge 236 of CLK signal 202, flip-flop latch 144 latches a logic high M1 signal passed from logic high A1 signal 208 to provide rising edge 278 of OUT_{A} signal 222. In response to rising edge 246 of CLK signal 202, flip-flop latch 144 latches a logic low M1 signal passed from logic low A1 signal 208 to provide falling edge 280 of OUT_{A} signal 222. If multiplexer 146 is set to pass B1 signal 212, in response to rising edge 246 of CLK signal 202, flip-flop latch 144 latches a logic high M1 signal passed from logic high B1 signal 212 to provide rising edge 282 of OUT_{B} signal 224. In response to rising edge 258 of CLK signal 202, flip-flop latch 144 latches a logic low M1 signal passed from logic low B1 signal 212 to provide falling edge 284 of OUT_{B} signal 224. If multiplexer 146 is set to pass C1 signal 216, in response to rising edge 258 of CLK signal 202, flip-flop latch 144 latches a logic high M1 signal passed from logic high C1 signal 216 to provide rising edge 286 of OUT_{C} signal 226. In response to rising edge 270 of CLK signal 202, flip-flop latch 144 latches a logic low M1 signal passed from logic low C1 signal 216 to provide falling edge 288 of OUT_{C} signal 226. If multiplexer 146 is set to pass D1 signal 220, in response to rising edge 270 of CLK signal 202, flip-flop latch 144 latches a logic high M1 signal passed from logic high D1 signal 220 to provide rising edge 290 of OUT_{D} signal 228. In response to rising edge 294 of CLK signal 202, flip-flop latch 144 latches a logic low M1 signal passed from logic low D1 signal 220 to provide falling edge 292 of OUT_{D} signal 228.

As illustrated in timing diagram 200, the delay between each signal selection (OUT_{A}, OUT_{B}, OUT_{C}, and OUT_{D}) is one cycle of CLK signal 202. In addition, the delay through multiplexer 146 is hidden within the one cycle delay. For example, A2 signal 210 is similar to OUT_{A} signal 222, B2 signal 214 is similar to OUT_{B} signal 224, and C2 signal 218 is similar to OUT_{C} signal 226. Therefore, the delay through multiplexer 146 does not add to the total delay between the OUT signal and the IN signal. The present invention provides a variable pipeline having no additional delay due to selecting the length of the delay.

What is claimed is:

1. A variable pipeline comprising:
a first pipeline element configured to latch a first signal in response to a first edge of a clock signal to provide a second signal;
a selection circuit configured to select the second signal and pass the second signal to provide a third signal; and
a second pipeline element configured to latch the third signal in response to a second edge of the clock signal to provide a fourth signal.

2. The variable pipeline of claim 1, wherein a total delay between the first signal and the fourth signal is not increased due to a delay of the selection circuit passing the second signal to provide the third signal.

3. The variable pipeline of claim 1, wherein the selection circuit comprises a multiplexer.

4. The variable pipeline of claim 1, wherein the first edge of the clock signal is a falling edge of the clock signal and the second edge of the clock signal is a rising edge of the clock signal.

5. The variable pipeline of claim 1, wherein the first pipeline element comprises a first flip-flop latch, and wherein the second pipeline element comprises a second flip-flop latch.

6. A delay circuit comprising:
means for delaying a first signal by a first delay to provide a first delayed signal;
means for selecting the first delayed signal to provide a selected signal; and
means for delaying the selected signal by a second delay to provide a second delayed signal,
wherein a total delay between the second delayed signal and the first signal is not increased by a delay due to the means for selecting the first delayed signal.

7. The delay circuit of claim 6, further comprising:
means for delaying the first delayed signal by a third delay to provide a third delayed signal,
wherein the third delayed signal is equal to the second delayed signal.

8. The delay circuit of claim 6, wherein the means for delaying the first signal by the first delay comprises means for latching the first signal in response to a first edge of a clock signal.

9. The delay circuit of claim 8, wherein the means for delaying the selected signal by the second delay comprises means for latching the selected signal in response to a second edge of the clock signal.

10. A memory circuit comprising:
a variable pipeline comprising:
a first pipeline element configured to latch a first signal in response to a first edge of a clock signal to provide a second signal;
a multiplexer configured to select the second signal and pass the second signal to provide a third signal; and
a second pipeline element configured to latch the third signal in response to a second edge of the clock signal to provide a fourth signal; and
a memory coupled to the variable pipeline.

11. The memory circuit of claim 10, wherein a total delay between the first signal and the fourth signal is not increased due to a delay of the selection circuit passing the second signal to provide the third signal.

12. The memory circuit of claim 10, wherein the first pipeline element is a first flip-flop latch, and wherein the second pipeline element is a second flip-flop latch.

13. The memory circuit of claim 10, wherein the memory comprises a random access memory.

14. The memory circuit of claim 10, wherein the memory comprises a dynamic random access memory.

15. The memory circuit of claim 10, wherein the memory comprises a synchronous dynamic random access memory.

16. The memory circuit of claim 10, wherein the memory comprises a double data rate synchronous dynamic random access memory.

17. The memory circuit of claim 10, wherein the memory comprises a double data rate two synchronous dynamic random access memory.

18. A method for variably delaying a signal, the method comprising:
delaying a first signal by a first delay to provide a first delayed signal;
selecting the first delayed signal to provide a selected signal; and
delaying the selected signal by a second delay to provide a second delayed signal,
wherein a total delay between the second delayed signal and the first signal is not increased by a delay due to selecting the first delayed signal.

19. The method of claim 18, wherein delaying the selected signal comprises delaying the selected signal by one half of a clock cycle.

20. The method of claim 18, further comprising:
delaying the first delayed signal to provide a third delayed signal,
wherein the third delayed signal is delayed one clock cycle from the first delayed signal.

21. The method of claim 18, wherein delaying the first signal by the first delay comprises latching the first signal in response to a first edge of a clock signal to provide the first delayed signal.

22. A variable pipeline comprising:
a first pipeline element configured to latch a first signal in response to a first edge of a clock signal to provide a second signal;
a second pipeline element configured to latch the second signal in response to a second edge of the clock signal to provide a third signal;
a third pipeline element configured to latch the third signal in response to a third edge of the clock signal to provide a fourth signal;
a selection circuit configured to select one of the second signal and the fourth signal and pass the selected one of the second signal and the fourth signal to provide a fifth signal; and
a fourth pipeline element configured to latch the fifth signal in response to a fourth edge of the clock signal to provide a sixth signal.

23. The variable pipeline of claim 22, further comprising:
a fifth pipeline element configured to latch the fourth signal in response to a fifth edge of the clock signal to provide a seventh signal; and
a sixth pipeline element configured to latch the seventh signal in response to a sixth edge of the clock signal to provide an eighth signal,
wherein the selection circuit is configured to select one of the second signal, the fourth signal, and the eighth signal and pass the selected one of the second signal, the fourth signal, and the eighth signal to provide the fifth signal.

24. The variable pipeline of claim 23, further comprising:
a seventh pipeline element configured to latch the eighth signal in response to a seventh edge of the clock signal to provide a ninth signal; and
an eighth pipeline element configured to latch the ninth signal in response to an eighth edge of the clock signal to provide a tenth signal,
wherein the selection circuit is configured to select one of the second signal, the fourth signal, the eighth signal, and the tenth signal and pass the selected one of the second signal, the fourth signal, the eighth signal, and the tenth signal to provide the fifth signal.

25. The variable pipeline of claim 24, wherein a total delay between the first signal and the sixth signal is not increased due to a delay of the selection circuit passing the selected one of the second signal, the fourth signal, the eighth signal, and the tenth signal.

26. The variable pipeline of claim 25, wherein the selection circuit comprises a multiplexer.

27. The variable pipeline of claim 26, wherein the first pipeline element comprises a first flip-flip latch, the second pipeline element comprises a second flip-flop latch, the third pipeline element comprises a third flip-flop latch, the fourth pipeline element comprises a fourth flip-flop latch, the fifth pipeline element comprises a fifth flip-flop latch, the sixth pipeline element comprises a sixth flip-flop latch, the seventh pipeline element comprises a seventh flip-flop latch, and the eighth pipeline element comprises an eighth flip-flop latch.
